(19) United States
(12) Patent Application Publication
(10) Pub. No.: US 2026/0313066 A1
(43) Pub. Date: Oct. 8, 2026

(54) IMAGE PROCESSING APPARATUS, IMAGE PROCESSING METHOD, AND NON-TRANSITORY COMPUTER-READABLE MEDIUM

(71) Applicant: SHARP KABUSHIKI KAISHA, Sakai City (JP)

(72) Inventor: TOMOE KAYANO, Sakai City (JP)

(21) Appl. No.: 19/638,535

(22) Filed: Apr. 3, 2026

(30) Foreign Application Priority Data
Apr. 7, 2025 (JP) 2025062965

(51) Int. Cl. H04N 1/60; G06T 5/40; G06V 10/56

(52) U.S. Cl. CPC H04N 1/60; G06T 5/40; G06V 10/56; G06T 2207/10024

(57) ABSTRACT

An image processing apparatus includes: a feature value acquirer that acquires a density element related to density as a feature value for each of a plurality of pieces of image data read and obtained by an image reading device; an information inputter that inputs, to a learning model, the feature value for each of the plurality of pieces of image data and base removal information indicating a density range of a target to be removed as a color of a base region included in each of the plurality of pieces of image data; and a machine learner that performs machine learning on the learning model based on the feature value and the base removal information that are input.

### CROSS-REFERENCE TO RELATED APPLICATION

The present application claims priority from Japanese Application JP2025-62965, filed on Apr. 7, 2025, the content of which is hereby incorporated by reference into this application.

### BACKGROUND

### 1. Field

The disclosure relates to an image processing apparatus, an image processing method, and a non-transitory computer-readable medium.

### 2. Description of the Related Art

A related art discloses an image processing apparatus that determines whether or not a read document is a double-sided document and, in a case of determining that the read document is a double-sided document, executes show-through prevention processing on document data based on the read document. The image processing apparatus disclosed in the related art executes background color removal processing in a case of determining that the read document is a one-sided document.

### SUMMARY

In the related art, show-through prevention processing or background color removal processing is executed for a predetermined density range. However, in the related art, there is a possibility that the color of a base region having a density not included in the predetermined range cannot be removed. Therefore, it is preferable that the density range of the target to be removed as the color of the base region be appropriately determined in accordance with a read document. Therefore, an object of one aspect of the disclosure is to provide an image processing apparatus, an image processing method, and a non-transitory computer-readable medium that can appropriately determine a density range of a target to be removed as a color of a base region.

An image processing apparatus according to one form of the disclosure includes: an image acquirer that acquires a plurality of pieces of image data read by an image reading device; and one or more controllers, in which the one or more controllers acquire a density element related to density as a feature value for each of the plurality of pieces of image data, input, to a learning model, the feature value for each of the plurality of pieces of image data and base removal information indicating a density range of a target to be removed as a color of a base region included in each of the plurality of pieces of image data, and perform machine learning on the learning model based on the feature value and the base removal information that are input.

An image processing method according to one form of the disclosure includes: acquiring a density element related to density as a feature value for each of a plurality of pieces of image data read and obtained by an image reading device; inputting, to a learning model, the feature value for each of the plurality of pieces of image data and base removal information indicating a density range of a target to be removed as a color of a base region included in each of the plurality of pieces of image data; and performing machine learning on the learning model based on the feature value and the base removal information that are input.

A non-transitory computer-readable medium according to one form of the disclosure records a program for causing a computer that controls an image processing apparatus to execute acquiring a density element related to density as a feature value for each of a plurality of pieces of image data read and obtained by an image reading device; inputting, to a learning model, the feature value for each of the plurality of pieces of image data and base removal information indicating a density range of a target to be removed as a color of a base region included in each of the plurality of pieces of image data; and performing machine learning on the learning model based on the feature value and the base removal information that are input.

### BRIEF DESCRIPTION OF THE DRAWINGS

FIG. 1A is a block diagram illustrating an example of a configuration of an image processing apparatus that generates a learning model.

FIG. 1B is a block diagram illustrating an example of a configuration of the image processing apparatus that removes a color of a base region.

FIG. 2 is a block diagram for explaining a feature value acquirer, a first base removal information determiner, an information inputter, and a machine learner.

FIG. 3 is a view illustrating an example of a configuration of a first feature value.

FIG. 4 is a view illustrating an example of a relationship among a plurality of first feature values, a learning model, and a plurality of pieces of first base removal information.

FIG. 5 is a block diagram for explaining a second base removal information acquirer and a base color remover.

FIG. 6 is a view illustrating an example of a configuration of a second feature value.

FIG. 7 is a flowchart showing an example of processing of generating a learning model in the image processing apparatus.

FIG. 8 is a flowchart showing an example of processing of generating the learning model in the image processing apparatus subsequent to FIG. 7.

FIG. 9A is a view illustrating an example of image data without show-through.

FIG. 9B is a view illustrating an example of image data with show-through.

FIG. 10 is a view illustrating an example of a first feature value for the image data exemplified in FIG. 9A and an example of a first feature value for the image data exemplified in FIG. 9B.

FIG. 11 is a view illustrating an example of a relationship among a first feature value, a learning model, and first base removal information for a plurality of documents.

FIG. 12 is a view illustrating an example of processing of removing a color of a base region in the image processing apparatus.

FIG. 13 is a view illustrating an example of processing of removing the color of the base region in the image processing apparatus subsequent to FIG. 12.

FIG. 14 is a graph showing an example of a base removal coefficient in a case in which there is no show-through in second document data.

FIG. 15 is a graph showing an example of a base removal coefficient in a case in which there is show-through in the second document data.

FIG. 16 is a view illustrating an example of a configuration of an image processing apparatus according to a second embodiment.

### DETAILED DESCRIPTION OF THE DISCLOSURE

### First Embodiment

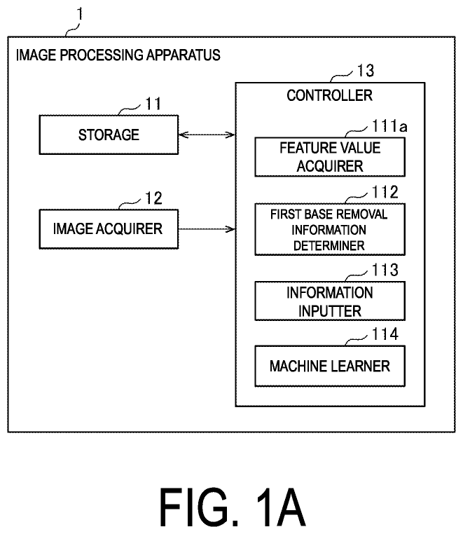

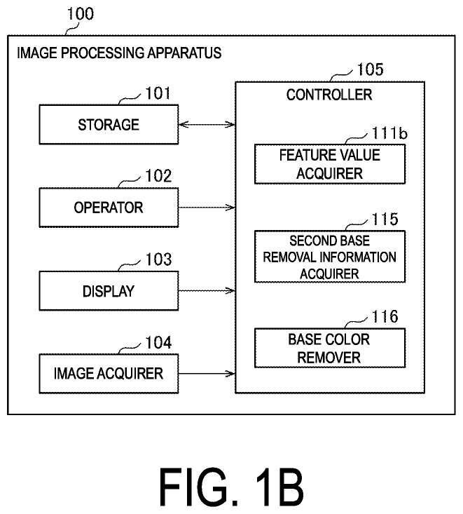

A first embodiment will be described with reference to FIGS. 1A to 15. In the drawings, the same or equivalent elements are denoted by the same reference signs, and redundant descriptions are omitted.

Configurations of an image processing apparatus 1 and an image processing apparatus 100 will be described with reference to FIGS. 1A and 1B. The image processing apparatus 1 exemplified in FIG. 1A and the image processing apparatus 100 exemplified in FIG. 1B are connected via a network. For example, the network is the Internet, a local area network (LAN), or the like.

The image processing apparatus 1 acquires image data, and performs machine learning on a relationship between a feature value for the image data and first base removal information indicating a density range of a target to be removed as a color of a base region included in the image data to generate a learning model. The image processing apparatus 1 transmits the generated learning model to the image processing apparatus 100.

The image processing apparatus 100 acquires image data, and, using the learning model generated by the image processing apparatus 1, determines the density range of the target to be removed as the color of the base region for the image data acquired by the image processing apparatus 100. Then, based on the determined density range, the image processing apparatus 100 executes processing of removing the color of the base region for the image data acquired by the image processing apparatus 100.

FIG. 1A is a block diagram illustrating an example of the configuration of the image processing apparatus 1. The image processing apparatus 1 includes a storage 11, an image acquirer 12, and one or more controllers 13.

The storage 11 is a recording medium that can record various types of data, programs, and the like. The storage 11 is constituted by, for example, one or more hard disk drives (HDDs), one or more solid state drives (SSDs), one or more semiconductor memories, and the like.

The image acquirer 12 acquires image data. Specifically, the image acquirer 12 acquires image data read and obtained by an image reading device (not illustrated). In the disclosure, image data to be used for machine learning is referred to as first image data TIM.

The controller 13 controls the entire image processing apparatus 1. The controller 13 implements various functions by reading and executing various programs stored in the storage 11. The controller 13 may be implemented by one or a plurality of control devices/arithmetic devices (central processing units (CPUs) and systems on a chip (SoCs)), one or more random access memories (RAMs), one or more read only memories (ROMs), various interface circuits, and the like. Some or all of the processors included in the controller 13 may be constituted by electronic circuits.

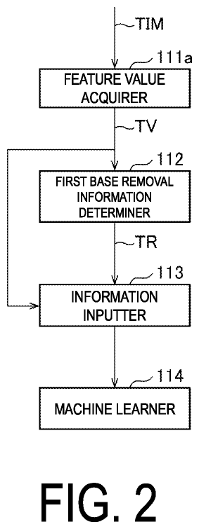

The controller 13 includes a feature value acquirer 111a, a first base removal information determiner 112, an information inputter 113, and a machine learner 114. By executing processing in accordance with a program and data stored in the storage 11, the controller 13 implements the feature value acquirer 111a, the first base removal information determiner 112, the information inputter 113, and the machine learner 114. Details of the feature value acquirer 111a, the first base removal information determiner 112, the information inputter 113, and the machine learner 114 will be described later with reference to FIG. 2.

FIG. 1B is a block diagram illustrating an example of the configuration of the image processing apparatus 100. The image processing apparatus 100 includes a storage 101, an operator 102, a display 103, an image acquirer 104, and a controller 105.

The storage 101 is a recording medium that can record various types of data, programs, and the like. The storage 101 is constituted by, for example, one or more HDDs, one or more SSDs, one or more semiconductor memories, and the like. The storage 101 stores a learning model MD generated by performing machine learning by the machine learner 114 (see FIG. 1A). Details of the learning model MD will be described later.

The operator 102 receives an operation by a user. For example, the operator 102 receives an operation of selecting a function to be equipped on the image processing apparatus 100. The operator 102 is constituted by a touch panel or the like.

The display 103 displays information presented to the user. For example, the display 103 is constituted by a liquid crystal panel, an organic electro-luminescence (EL) panel, or the like.

The image acquirer 104 acquires image data. Specifically, the image acquirer 104 acquires image data read and obtained by the image reading device (not illustrated). In the disclosure, image data to be used for machine learning is referred to as the first image data TIM. In the disclosure, image data on which the processing of removing the color of the base region is executed is referred to as second image data IM.

The controller 105 controls the entire image processing apparatus 100. The controller 105 implements various functions by reading and executing various programs stored in the storage 101. The controller 105 may be implemented by one or a plurality of control devices/arithmetic devices (central processing units (CPUs) and systems on a chip (SoCs)), one or more random access memories (RAMs), one or more read only memories (ROMs), various interface circuits, and the like. Some or all of the processors included in the controller 105 may be constituted by electronic circuits.

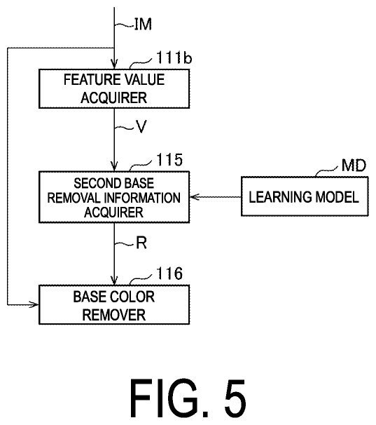

The controller 105 includes a feature value acquirer 111b, a second base removal information acquirer 115, and a base color remover 116. By executing processing in accordance with a program and data stored in the storage 101, the controller 105 implements the feature value acquirer 111b, the second base removal information acquirer 115, and the base color remover 116. Details of the feature value acquirer 111b, the second base removal information acquirer 115, and the base color remover 116 will be described later with reference to FIG. 5.

The feature value acquirer 111a, the first base removal information determiner 112, the information inputter 113, and the machine learner 114 will be described in detail with reference to FIG. 2.

The image acquirer 104 acquires a plurality of pieces of the first image data TIM read by the image reading device. The feature value acquirer 111a acquires a first feature value TV based on a plurality of pixel values included in the first image data TIM for each of the plurality of pieces of first image data TIM. The feature value acquirer 111a acquires, as the first feature value TV, a density element related to density for each of the plurality of pieces of first image data TIM read and obtained by the image reading device. Furthermore, the feature value acquirer 111a acquires, as first elements constituting the first feature value TV, a saturation element related to saturation, an image object element related to an image object, and a base element related to a base region. The image object is an image, a character, a line, or the like included in the image data.

The first base removal information determiner 112 determines, as first base removal information TR, an optimum density range for removing the color of the base region included in the first image data TIM that is input, for each piece of the first image data TIM. Specifically, the first base removal information determiner 112 determines, as the first base removal information TR, the density range input by the user, for each piece of the first image data TIM. The density range input by the user is determined by the user in accordance with the first image TM and the first feature value TV. Alternatively, the first base removal information determiner 112 may determine the first base removal information TR based on the first feature value TV for each piece of the first image data TIM.

The information inputter 113 inputs, to the learning model MD, the first feature value TV for each of the plurality of pieces of first image data TIM and the first base removal information TR for each of the plurality of pieces of first image data.

The machine learner 114 performs machine learning of the learning model MD based on the first feature value TV and the first base removal information TR input by the information inputter 113. The machine learner 114 generates the learning model MD by associating the first feature value TV for each of the plurality of first documents TIM with the first base removal information TR for each of the plurality of first documents TIM. Specifically, the machine learner 114 learns the first feature value TV for each of the plurality of first documents TIM as an explanatory variable and the first base removal information for each of the plurality of first documents TIM as an objective variable, and generates the learning model MD. The machine learner 114 causes the storage 11 to store the learning model MD that is generated. Then, the controller 13 transmits the learning model MD stored in the storage 11 to the image processing apparatus 100. For example, the controller 13 transmits the learning model MD to the image processing apparatus 100 in response to a request from the image processing apparatus 100.

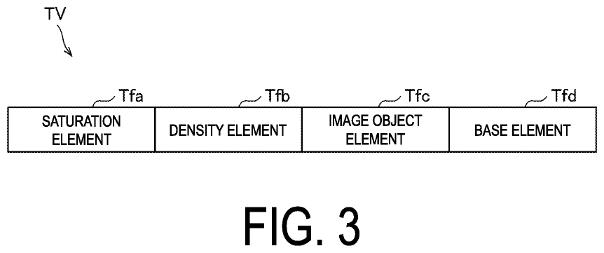

FIG. 3 is a view illustrating an example of the configuration of the first feature value TV. The first feature value TV includes a saturation element Tfa, a density element Tfb, an image object element Tfc, and a base element Tfd.

The saturation element Tfa indicates a feature related to the saturation of the first image data TIM. The saturation element Tfa is calculated based on the frequency of a saturation histogram for the first image data TIM. Specifically, the saturation element Tfa indicates a value in which the frequency of the saturation histogram of a base region included in the first image data TIM is normalized by the total number of pixels of the base region. The frequency of the saturation histogram indicates, for each of a plurality of sections of saturation, the frequency of the saturation belonging to the section. For example, the feature value acquirer 111a calculates the frequency of the saturation histogram for each range by assigning the difference between the maximum value and the minimum value among the pixel value of a color component R, the pixel value of a color component G, and the pixel value of a color component B to the range to which the difference belongs.

The density element Tfb indicates a feature related to the density of the first image data TIM. For example, the density element Tfb indicates a value in which the frequency of the density histogram of the base region included in the first image data TIM is normalized. Specifically, the density element Tfb indicates a value in which the frequency of the density histogram of a base region included in the first image data TIM is normalized by the total number of pixels of the base region. The frequency of the density histogram indicates, for each of a plurality of sections of density, the frequency of the density belonging to the section. For example, the feature value acquirer 111a calculates the frequency of the density histogram for each range by assigning the minimum value among the pixel value of the color component R, the pixel value of the color component G, and the pixel value of the color component B to the range to which the minimum value belongs.

The image object element Tfc indicates a feature related to an image object. Specifically, the image object element Tfc indicates features related to an image, a color, and a character included in the first image data TIM. The image object element Tfc indicates a value in which the number of pixels of the image object included in the image data is normalized by the total number of pixels included in the first image data TIM. The number of pixels of the image object indicates at least any one of the number of chromatic character pixels, the number of achromatic character pixels, and the number of halftone pixels. Therefore, the image object element Tfc indicates a value in which at least any one of the number of chromatic character pixels, the number of achromatic character pixels, and the number of halftone pixels included in the first image data TIM is normalized. Specifically, the image object element Tfc indicates a value in which any one of the number of chromatic character pixels, the number of achromatic character pixels, and the number of halftone pixels is normalized by the total number of pixels included in the first image data TIM. That is, the image object element Tfc indicates a ratio of at least any one of the number of chromatic character pixels, the number of achromatic character pixels, and the number of halftone pixels included in the first image data TIM.

For example, the feature value acquirer 111a determines, for each pixel of the first image data TIM, whether the pixel is a chromatic character pixel, an achromatic character pixel, a halftone pixel, or a pixel included in the base region. For example, by using optical character recognition (OCR), the feature value acquirer 111a identifies a character. Alternatively, the feature value acquirer 111a may detect an edge from the pixel values of a plurality of peripheral pixels including a determination target pixel and identify a character based on the number of edges. For example, the feature value acquirer 111a detects halftone dots from the pixel values of the plurality of peripheral pixels including the determination target pixel.

In a case in which the pixel value of each pixel is indicated by the pixel value of the color component R, the pixel value of the color component G, and the pixel value of B of the color component, in a case in which the pixel value of the color component R, the pixel value of the color component G, and the pixel value of B of the color component are not identical for the pixel constituting a character, the feature value acquirer 111a determines that the pixel is a pixel of a chromatic character. The feature value acquirer 111a calculates, as the number of chromatic character pixels, the total number of pixels of the chromatic character included in the first image data TIM. For example, the ratio of the number of chromatic character pixels indicated by the image object element Tfc is calculated by an equation of the ratio of the number of chromatic character pixels=the number of chromatic character pixels/the total number of pixels included in the first image data TIM×K. K is a predetermined value.

In a case in which the pixel value of each pixel is indicated by the pixel value of the color component R, the pixel value of the color component G, and the pixel value of B of the color component, in a case in which the pixel value of the color component R, the pixel value of the color component G, and the pixel value of B of the color component are identical for the pixel constituting a character, the feature value acquirer 111a determines that the pixel is a pixel of an achromatic character. The feature value acquirer 111a calculates, as the number of achromatic character pixels, the total number of pixels of the achromatic character included in the first image data TIM. For example, the ratio of the number of achromatic character pixels indicated by the image object element Tfc is calculated by an equation of the ratio of the number of achromatic character pixels=the number of achromatic character pixels/the total number of pixels included in the first image data TIM×K.

The feature value acquirer 111a calculates, as the number of halftone pixels, the total number of halftone pixels included in the first image data TIM. For example, the ratio of the number of halftone pixels indicated by the image object element Tfc is calculated by an equation of the ratio of the number of halftone pixels=the number of halftone pixels/the total number of pixels included in the first image data TIM×K.

The base element Tfd indicates a feature related to a base region included in the first image data TIM. The base element Tfd indicates a value in which the number of pixels of the base region included in the first image data TIM is normalized by the total number of pixels included in the first image data TIM. That is, base element Tfd indicates the ratio of the number of pixels of the base region included in first image data TIM. For example, the ratio of the number of pixels of the base region indicated by the base element Tfd is calculated by an equation of the ratio of the number of pixels of the base region=the total number of pixels of the base region/total number of pixels of the first image data TIM×K.

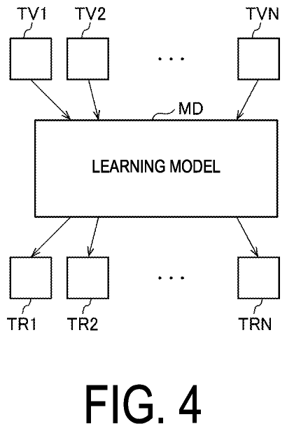

FIG. 4 is a view illustrating an example of the relationship among first feature values TV1 to TVN, respectively, for N pieces of the first image data TIM, the learning model MD, and first base removal information TRI to TRN, respectively, for N pieces of the image data TIM.

The machine learner 114 performs machine learning of the learning model MD based on the first feature values TV1 to TVN and the first base removal information TRI to TRN input by the information inputter 113. Specifically, the machine learner 114 performs machine learning of the learning model MD in association with the feature value TV and the base removal information TR, with the first feature values TV1 to TVN as explanatory variables and the first base removal information TRI to TRN as objective variables. For example, the learning model MD is a neural network.

Next, the second base removal information acquirer 115 and the base color remover 116 will be described in detail with reference to FIG. 5.

The image acquirer 104 acquires at least one piece of the second image data IM read by the image reading device. The feature value acquirer 111b acquires a second feature value V based on a plurality of pixel values included in the second image data IM. The second feature value V is constituted to include second elements belonging to a plurality of respective types. Each second element included in the second feature value V belongs to the same type as each first element included in the first feature value TV.

The second base removal information acquirer 115 inputs the second feature value V to the learning model MD to acquire second base removal information R output from the learning model MD.

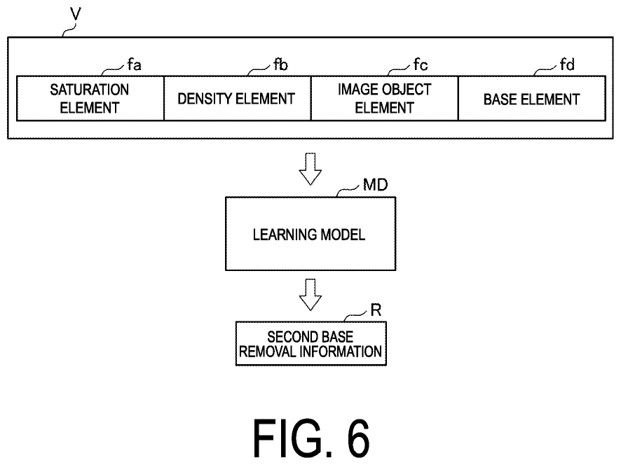

FIG. 6 is a view illustrating an example of the configuration of the second feature value V. The second feature value V includes a saturation element fa, a density element fb, an image object element fc, and a base element fd.

The saturation element fa indicates a feature related to the saturation of the base region included in the second image data IM. The feature value acquirer 111b calculates the frequency for each of the plurality of saturation sections indicated by the saturation histogram from the pixel values included in the base region included in the second image data IM. Specifically, the saturation element fa indicates, for each of the plurality of saturation sections, a value in which the frequency of the saturation histogram of the base region included in the second image data IM is normalized by the total number of pixels of the base region included in the second image data IM.

The density element fb indicates a feature related to the density of the base region included in the second image data IM. The feature value acquirer 111b calculates the frequency of each of the plurality of density sections indicated by the density histogram from the pixel values of the pixels included in the base region included in the second image data IM. Specifically, the density element fb indicates, for each of the plurality of density sections, a value in which the frequency of the density histogram of the base region included in the second image data IM is normalized by the total number of pixels of the base region included in the second image data IM.

The image object element fc indicates a feature related to an image object. Specifically, the image object element fc indicates features related to an image, a color, and a character included in the second image data IM. The image object element fc indicates a value in which the number of pixels of the image object included in the second image data IM is normalized by the total number of pixels included in the second image data IM. Therefore, the image object element fc indicates a value in which at least any one of the number of chromatic character pixels, the number of achromatic character pixels, and the number of halftone pixels included in the second image data IM is normalized. The calculation methods for the number of chromatic character pixels, the number of achromatic character pixels, and the number of halftone pixels included in the second image data IM are similar to the calculation methods for the number of chromatic character pixels, the number of achromatic character pixels, and the number of halftone pixels included in the first image data TIM, and therefore detailed description will be omitted.

The base element fd indicates the ratio of the number of pixels of the base region included in the second image data IM. Specifically, the base element fd indicates a value in which the number of pixels of the base region included in the second image data IM is normalized by the total number of pixels included in the second image data IM. That is, the base element fd indicates the ratio of the number of pixels of the base region included in the second image data IM. For example, the ratio of the number of pixels of the base region indicated by the base element fd is calculated by an equation of the ratio of the number of pixels of the base region=the total number of pixels of the base region/total number of pixels of the second image data IM×K.

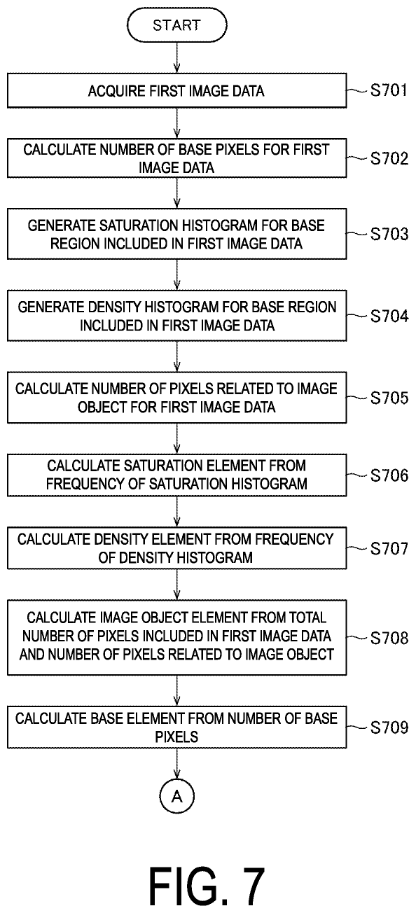

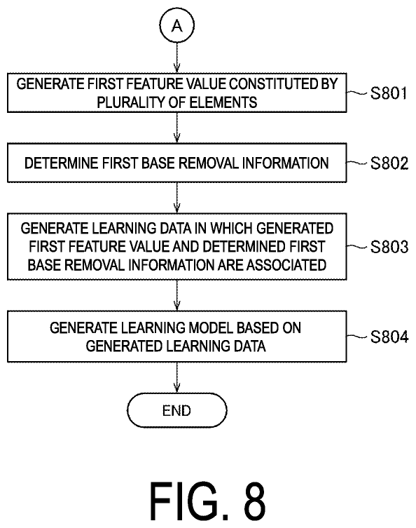

Next, the operation of the image processing apparatus 100 according to the present embodiment will be described with reference to FIGS. 7 and 8.

FIG. 7 is a flowchart showing an example of processing of generating the learning model MD in the image processing apparatus 100.

In step S701, the image acquirer 104 acquires the first image data TIM.

In step S702, the feature value acquirer 111a calculates the number of base pixels for the first image data TIM. For example, the feature value acquirer 111a generates a density histogram for a plurality of sections between the minimum value of the gradation values of the pixel values and the maximum value of the gradation values of the pixel values for the first image data TIM. Then, the feature value acquirer 111a determines, for the first image data TIM, the pixel value of a pixel whose frequency indicated by the generated density histogram is a threshold or more as a pixel value of a pixel included in the base region. Then, the feature value acquirer 111a calculates, as the number of base pixels, the frequency of the section to which the determined pixel value belongs in the density histogram.

In step S703, the feature value acquirer 111a generates a saturation histogram based on the pixel values of the pixels of the base region included in the first image data TIM.

In step S704, the feature value acquirer 111a generates a density histogram based on the pixel values of the pixels included in the base region included in the first image data TIM.

In step S705, the feature value acquirer 111a calculates the number of pixels related to the image object for the first image data TIM. For example, the feature value acquirer 111a calculates the number of pixels of at least any of the number of chromatic character pixels, the number of achromatic character pixels, and the number of halftone pixels for the first image data TIM.

In step S706, the feature value acquirer 111a calculates the saturation element Tfa based on the frequency indicated by the saturation histogram generated in step S702. For example, the feature value acquirer 111a calculates the saturation element Tfa based on the frequency of a saturation histogram of a predetermined saturation or less for the first image data TIM.

In step S707, the feature value acquirer 111a calculates the density element Tfb based on the frequency indicated by the density histogram generated in step S703. For example, the feature value acquirer 111a calculates the density element Tfb based on the frequency of a density histogram of a predetermined density or less for the first image data TIM.

In step S708, the feature value acquirer 111a calculates the image object element Tfc from the number of base pixels calculated in step S702 for the first image data TIM and the number of pixels related to the image object calculated in step S705. Specifically, the image object element Tfc indicates a value in which the number of pixels of the image object included in the first image data TIM is normalized by the total number of pixels included in the first image data TIM. The number of pixels of the image object indicates at least any one of the number of chromatic character pixels, the number of achromatic character pixels, and the number of halftone pixels.

In step S709, the feature value acquirer 111a calculates the base element Tfd from the number of base pixels calculated in step S702. The base element Tfd indicates a value in which the number of base pixels is normalized by the total number of pixels included in the first image data TIM. The controller 105 proceeds to step S801 exemplified in FIG. 8.

FIG. 8 is a flowchart showing an example of processing of generating the learning model MD in the image processing apparatus 100 subsequent to FIG. 7.

In step S801, the feature value acquirer 111a generates the first feature value TV constituted by a plurality of elements. Specifically, the feature value acquirer 111a generates the first feature value TV constituted by the saturation element Tfa calculated in step S706 exemplified in FIG. 7, the density element Tfb calculated in step S707 exemplified in FIG. 7, the image object element Tfc calculated in step S708 exemplified in FIG. 7, and the base element Tfd calculated in step S709 exemplified in FIG. 7.

In step S802, the first base removal information determiner 112 determines, as the first base removal information TR, an optimum density range for removing the color of the base region included in the input first image data TIM for the first image data TIM. For example, in the density histogram for the pixel values of the pixels included in the first image data TIM, the frequency of density of the base color can indicate the peak value. On the other hand, in the density histogram for the pixel values of the pixels included in the first image data TIM, in a case in which there is show-through, the frequency of density different from the peak value becomes high for the base region. In a case in which there is a section indicating a rise different from such a peak value, the density belonging to the section indicating the rise is input as an optimum density range for removing the color of the base region. Then, the first base removal information determiner 112 determines the input density range as the first base removal information TR. In a case in which there is no section indicating the rise, the first base removal information determiner 112 inputs, as the first base removal information TR, an optimum density range for removing the color of the base region indicated by the density belonging to the section indicating the peak value.

In step S803, the machine learner 114 generates learning data with the first feature value TV generated in step S801 as an explanatory variable and the first base removal information TR determined in step S802 as an objective variable.

In step S804, the machine learner 114 generates the learning model MD by machine learning using the generated learning data. For example, the learning model MD is a neural network. For example, in a case in which the learning model MD is a neural network, the learning model MD indicates information related to connections of units included in each of a plurality of layers constituting the neural network. For example, the activation function that implements the units is a normalized linear function (ReLU function). Alternatively, the activation function that implements the units may be a sigmoid function, a step function, or the like.

From the above, the image processing apparatus 100 according to the present embodiment generates the learning model MD by learning the relationship between the feature values acquired from the plurality of pieces of first document data TIM and the density range in which the color of the base region is removed. Furthermore, after generation of the learning model MD, the image processing apparatus 100 according to the present embodiment may relearn the relationship between the feature value acquired from the new first document data TIM and the density range in which the color of the base region is removed. This enables the image processing apparatus 100 according to the present embodiment to improve the accuracy of the learning model MD.

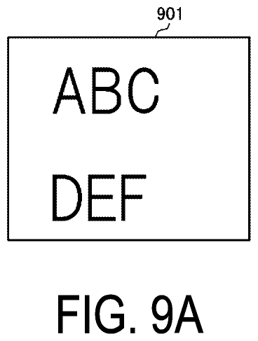

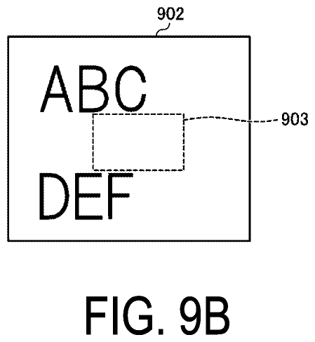

FIG. 9A is a view illustrating an example of image data 901 without show-through. The image data 901 includes image objects indicating characters “ABC” and characters “DEF”.

FIG. 9B is a view illustrating an example of image data 902 with show-through. The difference between the image data 901 and the image data 902 lies in that the image data 902 includes a region 903 with show-through.

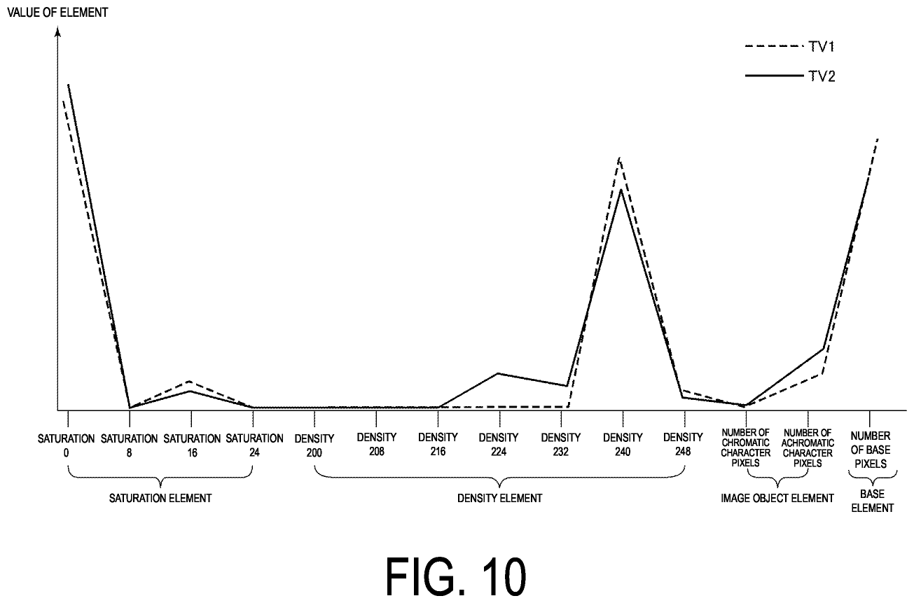

FIG. 10 is a view illustrating an example of the first feature value TV1 for the image data 901 exemplified in FIG. 9A and the first feature value TV2 for the image data 902 exemplified in FIG. 9B. In FIG. 10, the horizontal axis represents a plurality of items, and the vertical axis represents values indicated by the first element. Since the image data 901 and the image data 902 are different from each other, the first feature value TV1 and the first feature value TV2 are different from each other as exemplified in FIG. 10. That is, the first feature value TV varies depending on the document.

An element Tfa0 belonging to an item “saturation 0” indicates a value in which the frequency of a saturation histogram of 0 or more and 7 or less is normalized for the base region included in the first image data TIM. An element Tfa8 belonging to an item “saturation 8” indicates a value in which the frequency of a saturation histogram of 8 or more and 15 or less is normalized for the base region included in the first image data TIM. An element Tfa16 belonging to an item “saturation 16” indicates a value in which the frequency of a saturation histogram of 16 or more and 23 or less is normalized for the base region included in the first image data TIM. An element Tfa24 belonging to an item “saturation 24” indicates a value in which the frequency of a saturation histogram of 24 or more and 31 or less is normalized for the base region included in the first image data TIM. That is, the saturation element Tfa included in the first feature value TV is calculated based on the frequency of the saturation histogram of the predetermined saturation or less for the first image data TIM.

The element Tfa0 belonging to the item “saturation 0” indicates a value in which a number of pixels P0 in which a difference between the maximum value and the minimum value among the pixel value of the color component R, the pixel value of the color component G, and the pixel value of the color component B for the pixel values of the pixels included in the base region included in the first image data TIM is 0 or more and 7 or less is normalized by the total number of pixels of the base region. For example, the element Tfa0 is calculated by an equation of the element Tfa0=the number of pixels P0/the total number of pixels of the base region included in the first image data TIM× K. K is a predetermined value.

The element Tfa8 indicates a value in which a number of pixels P8 in which a difference between the maximum value and the minimum value among the pixel value of the color component R, the pixel value of the color component G, and the pixel value of the color component B for the pixel values of the pixels included in the base region included in the first image data TIM is 8 or more and 15 or less is normalized by the total number of pixels of the base region. For example, the element Tfa8 is calculated by an equation of the element Tfa8=the number of pixels P8/the total number of pixels of the base region included in the first image data TIM×K.

The element Tfa16 indicates a value in which a number of pixels P16 in which a difference between the maximum value and the minimum value among the pixel value of the color component R, the pixel value of the color component G, and the pixel value of the color component B for the pixel values of the pixels included in the base region included in the first image data TIM is 16 or more and 23 or less is normalized by the total number of pixels of the base region. For example, the element Tfa16 is calculated by an equation of the element Tfa16=the number of pixels P16/the total number of pixels of the base region included in the first image data TIM×K.

The element Tfa24 indicates a value in which a number of pixels P24 in which a difference between the maximum value and the minimum value among the pixel value of the color component R, the pixel value of the color component G, and the pixel value of the color component B for the pixel values of the pixels included in the base region included in the first image data TIM is 24 or more and 31 or less is normalized by the total number of pixels of the base region. For example, the element Tfa24 is calculated by an equation of the element Tfa24=the number of pixels P24/the total number of pixels of the base region included in the first image data TIM×K.

An element Tfb200 belonging to an item “density 200” indicates a value in which the frequency of a density histogram of 200 or more and 207 or less is normalized for the base region included in the first image data TIM.

An element Tfb208 belonging to an item “density 208” indicates a value in which the frequency of a density histogram of 208 or more and 215 or less is normalized for the base region included in the first image data TIM.

An element Tfb216 belonging to an item “density 216” indicates a value in which the frequency of a density histogram of 216 or more and 223 or less is normalized for the base region included in the first image data TIM.

An element Tfb224 belonging to an item “density 224” indicates a value in which the frequency of a density histogram of 224 or more and 231 or less is normalized for the base region included in the first image data TIM.

An element Tfb232 belonging to an item “density 232” indicates a value in which the frequency of a density histogram of 232 or more and 239 or less is normalized for the base region included in the first image data TIM.

An element Tfb240 belonging to an item “density 240” indicates a value in which the frequency of a density histogram of 240 or more and 247 or less is normalized for the base region included in the first image data TIM.

An element Tfb248 belonging to an item “density 248” indicates a value in which the frequency of a density histogram of 248 or more and 255 or less is normalized for the base region included in the first image data TIM. That is, the density element Tfa included in the first feature value TV is calculated based on the frequency of the density histogram of the predetermined density or less for the first image data TIM.

For example, the element Tfb200 indicates a value in which a number of pixels P200 in which a minimum value among the pixel value of the color component R, the pixel value of the color component G, and the pixel value of the color component B for the pixel values of the pixels included in the base region included in the first image data TIM is 200 or more and 207 or less is normalized by the total number of pixels of the base region. For example, the element Tfb200 is calculated by an equation of the element Tfb200=the number of pixels P200/the total number of pixels of the base region included in the first image data TIM×K. K is a predetermined value.

For example, the element Tfb248 indicates a value in which a number of pixels P248 in which a minimum value among the pixel value of the color component R, the pixel value of the color component G, and the pixel value of the color component B for the pixel values of the pixels included in the base region included in the first image data TIM is 248 or more and 255 or less is normalized by the total number of pixels of the base region. For example, the element Tfb248 is calculated by an equation of the element Tfb248=the number of pixels P248/the total number of pixels of the base region included in the first image data TIM× K. K is a predetermined value. The element Tfb208, the element Tfb216, the element Tfb224, the element Tfb232, and the element Tfb240 are also calculated by similar equations, and therefore detailed description will be omitted.

An element Tfc1 belonging to an item “the number of chromatic character pixels” indicates a value in which the number of chromatic character pixels included in the first image data TIM is normalized by the total number of pixels included in the first image data TIM.

An element Tfc2 belonging to an item “the number of achromatic character pixels” indicates a value in which the number of achromatic character pixels included in the first image data TIM is normalized by the total number of pixels included in the first image data TIM.

An element belonging to an item “the number of base pixels” indicates a value in which the number of pixels of the base region included in the first image data TIM is normalized by the total number of pixels included in the first image data TIM.

For the first feature value TV1 and the first feature value TV2 exemplified in FIG. 10, the element belonging to the item “density 240” in the density element Tfb indicates the peak value. However, there is show-through in the image data 902 corresponding to the first feature value TV2. Therefore, for the image data 902, it is preferable to remove a base color having a wider range of density than that of the image data 901. For the image data 902, by removing a base color having a wider range of density than that of the image data 901, the image processing apparatus 100 can remove a base color of a document and a color by show-through.

From the above, the image processing apparatus 100 according to the present embodiment can limit the number of elements included in the feature value by limiting the range of saturation and the range of density for the saturation histogram and the density histogram. This enables the image processing apparatus 100 according to the present embodiment to generate a learning model by learning a light color of a base with particularly conspicuous show-through for the document read by the document reading device. Furthermore, by limiting the range of saturation and the range of density, the image processing apparatus 100 according to the present embodiment can reduce the scale of the learning model MD.

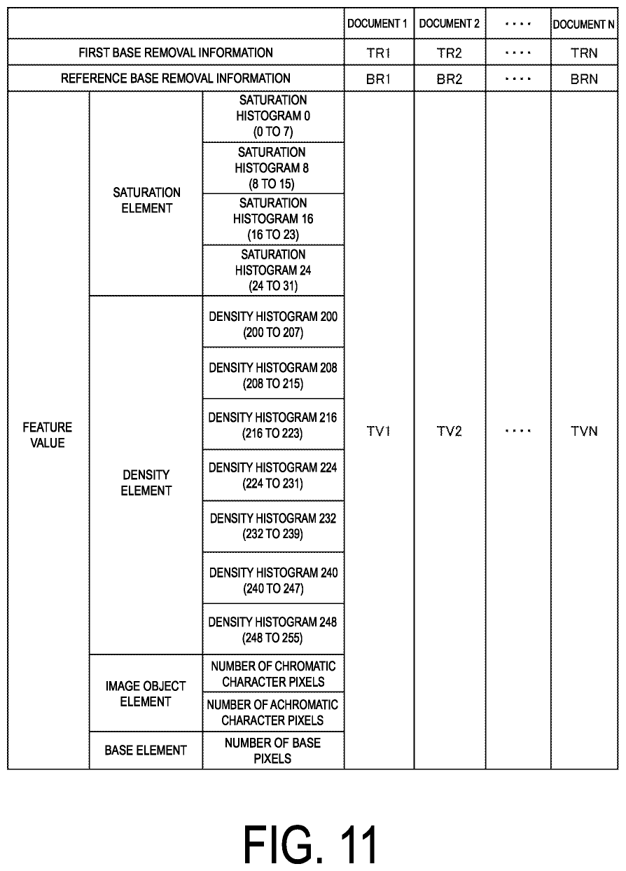

FIG. 11 is a view illustrating an example of the relationship among the first feature value TV, the learning model MD, and the first base removal information TR for a plurality of documents. As exemplified in FIG. 11, the feature value acquirer 111a acquires the first feature value TV1 to the first feature value TVN for a document 1 to a document N read by the image reading device. Here, it is preferable to uniformly use various documents as the document 1 to the document N.

Furthermore, as exemplified in FIG. 11, the first base removal information determiner 112 determines reference base removal information BR1 to reference base removal information BRN for the document 1 to the document N. For example, the reference base removal information BR1 to the reference base removal information BRN indicate a representative value of pixel values of pixels included in the base region for the document 1 to the document N, respectively. For example, the representative value indicates the density to which the frequency that is a peak value belongs in the density histogram of the base region for each of the document 1 to the document N.

Furthermore, as exemplified in FIG. 11, the first base removal information determiner 112 determines, as the first base removal information TR, an optimum density range for removing the color of the base region included in the first document data TIM that has been input, for the document 1 to the document N.

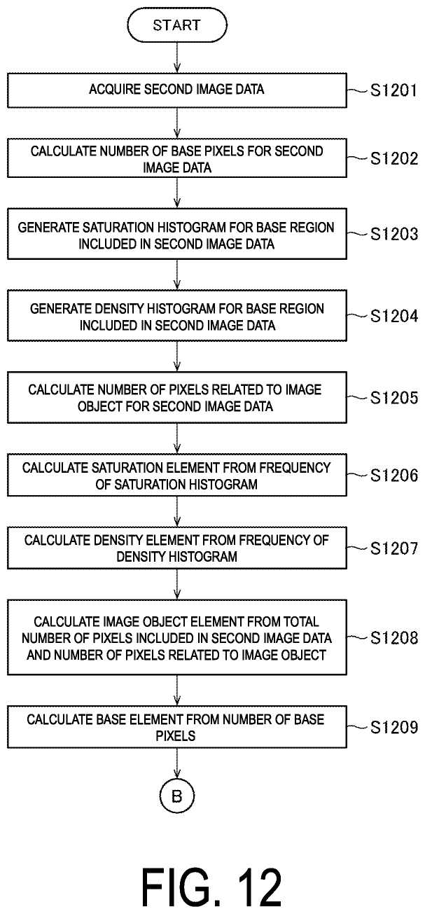

FIG. 12 is a view illustrating an example of processing of removing a color of a base region in the image processing apparatus 100. It is assumed that the learning model has been generated at the time point when the controller 105 executes the processing of step S1201 exemplified in FIG. 12.

In step S1201, the feature value acquirer 111b acquires the second image data IM read and obtained by the image reading device.

In step S1202, the feature value acquirer 111b calculates the number of base pixels for the second image data IM.

In step S1203, the feature value acquirer 111b generates a saturation histogram based on the pixel values of the pixels included in the base region included in the second image data IM. For example, the feature value acquirer 111b generates a saturation histogram based on the frequency of a saturation histogram of a predetermined saturation or less.

In step S1204, the feature value acquirer 111b generates a density histogram based on the pixel values of the pixels included in the base region included in the second image data IM.

In step S1205, the feature value acquirer 111b calculates the number of pixels related to the image object for the second image data IM. For example, the feature value acquirer 111b calculates, as the number of pixels related to the image object, the number of pixels of at least any of the number of chromatic character pixels, the number of achromatic character pixels, and the number of halftone pixels, for the second image data IM.

In step S1206, the feature value acquirer 111b calculates the saturation element fa from the frequency indicated by the saturation histogram generated in step S1203. For example, the feature value acquirer 111b calculates the saturation element fa based on the frequency of the saturation histogram of the predetermined saturation or less generated in step S1203. The predetermined saturation is identical to the predetermined saturation in S706 exemplified in FIG. 7.

In step S1207, the feature value acquirer 111b calculates the density element fb from the frequency indicated by the density histogram generated in step S1204. For example, the feature value acquirer 111b calculates the density element fb based on the frequency of the density histogram of the predetermined density or less generated in step S1204. The predetermined density is identical to the predetermined density in step S707 exemplified in FIG. 7.

In step S1208, the feature value acquirer 111b calculates an image object element related to the image object from the total number of pixels included in the second image data IM and the number of pixels related to the image object calculated in step S1205.

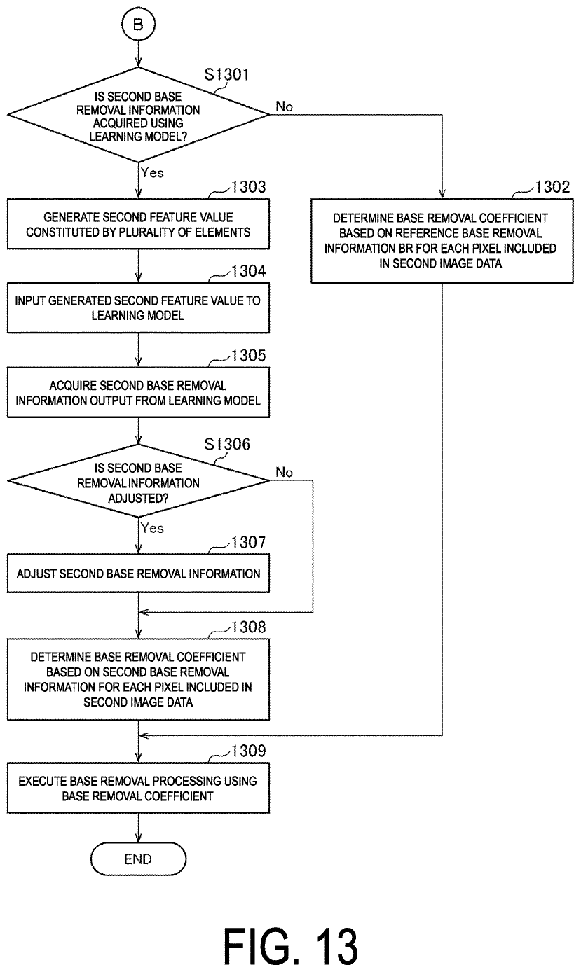

In step S1209, the feature value acquirer 111b calculates a base element belonging to an item related to the base from the number of base pixels calculated in step S1202. The controller 105 proceeds to step S1301 exemplified in FIG. 13. The processing of step S1201 to step S1209 is similar to the processing of step S701 to step S709 exemplified in FIG. 7, and therefore detailed description will be omitted.

FIG. 13 is a view illustrating an example of processing of removing the color of the base region in the image processing apparatus 100 subsequent to FIG. 12.

In step S1301, the second base removal information acquirer 115 determines whether or not to calculate the second base removal information R using the learning model. For example, the second base removal information acquirer 115 generates a density histogram for a plurality of sections between the minimum value of the gradation values of the pixel values and the maximum value of the gradation values of the pixel values for the second image data IM. Then, for the second image data IM, the second base removal information acquirer 115 sets, as reference base removal information BR, the density to which the frequency that is the peak value of the generated density histogram belongs as the representative value of the pixel values of the pixels included in the base region. In a case in which the reference base removal information BR that is determined is not within a predetermined range, the second base removal information acquirer 115 determines not to calculate the second base removal information R using the learning model MD. On the other hand, in a case in which the determined pixel value is within the predetermined range, the second base removal information acquirer 115 determines to calculate the second base removal information R using the learning model MD.

In a case in which it is determined in step S1301 that the second base removal information R is not calculated using the learning model, the base color remover 116 determines in step S1302 a base removal coefficient based on the reference base removal information BR acquired in step S1301. The controller 105 proceeds to step S1309.

On the other hand, in a case in which it is determined in step S1301 to calculate the second base removal information R using the learning model, the feature value acquirer 111b generates in step S1303 the second feature value V constituted by each element of a plurality of items.

In step S1304, the second base removal information acquirer 115 inputs, to the learning model MD, the second feature value V that is generated. For example, in a case in which the learning model MD is a neural network, each element constituting the second feature value V is input as an element constituting an input vector of the neural network. The input layer of the neural network indicated by the learning model MD has the same number of elements as the final layer of the neural network indicated by the learning model MD.

In step S1305, the second base removal information acquirer 115 acquires the second base removal information R output from the learning model MD. The second base removal information R indicates a density range of a target to be removed as the color of the base region included in the second image data IM. For example, the learning model MD is a neural network. In that case, the second base removal information acquirer 115 calculates the second base removal information R from the output of the final layer of the neural network that is the learning model MD. For example, the second base removal information acquirer 115 calculates the second base removal information R from the sum of the elements constituting the output vector of the final layer of the neural network that is the learning model MD.

In step S1306, the base color remover 116 determines whether or not to adjust the second base removal information R. Specifically, in a case in which the value indicated by the second base removal information R is a lower limit value or more and the value indicated by the second base removal information R is an upper limit value or less, the base color remover 116 determines not to adjust the second base removal information R. On the other hand, in a case in which the value indicated by the second base removal information R is smaller than the lower limit value or in a case in which the value indicated by the second base removal information R is larger than the upper limit value, the base color remover 116 determines to adjust a base removal coefficient γ. The base color remover 116 determines the lower limit value and the upper limit value based on the reference base removal information BR acquired in step S1301.

In a case in which it is determined in step S1306 that the second base removal information R is not adjusted, the controller 105 proceeds to step S1308. On the other hand, in a case in which it is determined to adjust the second base removal information R in step S1306, the base color remover 116 adjusts the second base removal information in step S1307. Specifically, in a case in which the value indicated by the second base removal information R exceeds the upper limit value, the base color remover 116 changes the value indicated by the second base removal information R to the upper limit value. Alternatively, in a case in which the value indicated by the second base removal information R is smaller than the lower limit value, the base color remover 116 changes the value indicated by the second base removal information R to the lower limit value.

In step S1308, the base color remover 116 determines the base removal coefficient Y based on the second base removal information R for each pixel included in the second image data.

In step S1309, the base color remover 116 executes the base removal processing using the base removal coefficient γ determined in step S1302 or step S1308.

For each pixel included in the second image data, the base color remover 116 reflects the base removal coefficient γ in the pixel value of each pixel to remove the color of the base region included in the second image data IM. Specifically, the base color remover 116 calculates the pixel value of each pixel using the base removal coefficient γ corresponding to the minimum pixel value among the pixel value of the color component R, the pixel value of the color component G, and the pixel value of the color component B of the pixels included in the second image data IM.

For example, in a case in which the gradation value of the pixel value is 256, the base color remover 116 corrects the second image data IM by reflecting the base removal coefficient γ that is calculated in the pixel value of each pixel by Equation 1 to Equation 3 for each pixel included in the second image data IM. By this, the base color remover 116 removes the color of the base region included in the second image data IM.

$$\begin{matrix}[ Equation 1 ] & \\ ( 255 - Rout ) = ( 255 - Rin ) \times γ / 256 & ( Equation 1 )\end{matrix}$$

$$\begin{matrix}[ Equation 2 ] & \\ ( 255 - Gout ) = ( 255 - Gin ) \times γ / 256 & ( Equation 2 )\end{matrix}$$

$$\begin{matrix}[ Equation 3 ] & \\ ( 255 - Bout ) = ( 255 - Bin ) \times γ / 256 & ( Equation 3 )\end{matrix}$$

In Equation 1 to Equation 3, Rin, Gin, and Bin are a pixel value of the color component R, a pixel value of the color component G, and a pixel value of the color component B for each pixel included in the second image data IM. In Equation 1 to Equation 3, Rout, Gout, and Bout are a pixel value of the color component R, a pixel value of the color component G, and a pixel value of the color component B for each pixel included in the second image data IM in which the color of the base region has been removed.

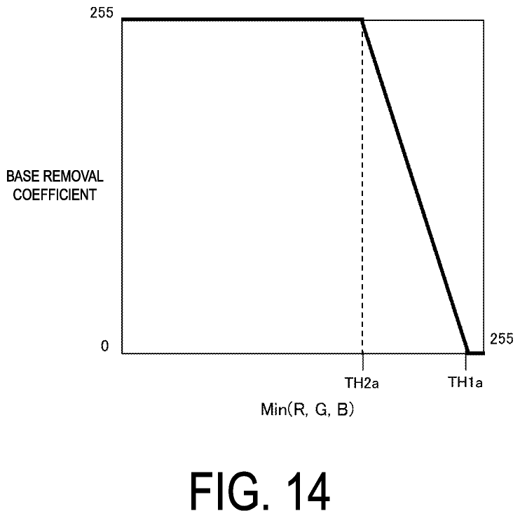

FIG. 14 is a graph showing an example of the base removal coefficient γ in a case in which there is no show-through in the second document data IM. In FIG. 14, the horizontal axis represents, for the pixel value of the color component R, the pixel value of the color component G, and the pixel value of the color component B constituting a pixel, a minimum value Min (R, G, B) of the pixel value, and the vertical axis represents the base removal coefficient γ. In the present example, a first threshold TH1a is a value indicated by the second base removal information R in a case in which there is no show-through in the second document data IM.

For example, in a case in which a minimum RGB pixel value is the first threshold TH1a or more for each pixel included in the second image data IM, the base color remover 116 sets the base removal coefficient γ=0, and calculates the pixel value Rout of the color component R included in the base region, the pixel value Gout of the color component G included in the base region, and the pixel value Bout of the color component B included in the base region as 255, which is the upper limit pixel value, by Equation 1 to Equation 3.

In a case in which the minimum RGB pixel value is the first threshold TH1a or more exemplified in FIG. 14, the base color remover 116 calculates the pixel value (Rout, Gout, Bout)=(255, 255, 255) for the pixel included in the base region. By this, the color of the base region becomes white, and the color of the base is removed.

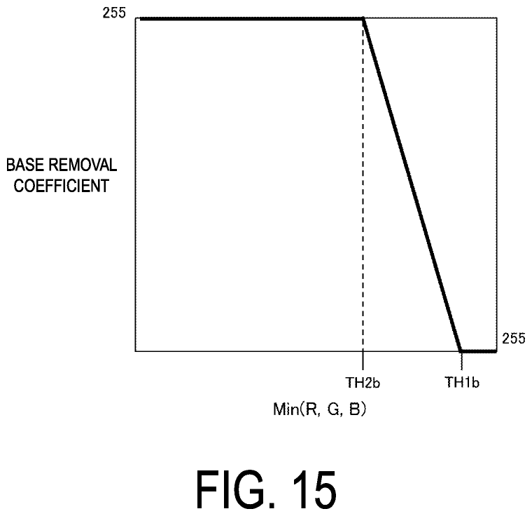

FIG. 15 is a graph showing an example of the base removal coefficient γ in a case in which there is show-through in the second document data IM. In FIG. 15, the horizontal axis represents, for the pixel value of the color component R, the pixel value of the color component G, and the pixel value of the color component B constituting a pixel, a minimum value Min (R, G, B) of the pixel value, and the vertical axis represents the base removal coefficient γ. In the present example, a first threshold TH1b is a value indicated by the second base removal information R in a case in which there is show-through in the second document data IM.

The first threshold TH1b exemplified in FIG. 15 is lower than the first threshold TH1a exemplified in FIG. 14. Therefore, in a case in which the base color remover 116 calculates the pixel value Rout, the pixel value Gout, and the pixel value Bout by Equation 1 to Equation 3 using the base removal coefficient γ exemplified in FIG. 15, the color of the base region becomes white for a wider pixel value range than that in the case in which the base color remover 116 calculates the pixel value Rout, the pixel value Gout, and the pixel value Bout by Equation 1 to Equation 3 using the base removal coefficient γ exemplified in FIG. 14, and the color of the base is removed.

For example, in a case in which a minimum RGB pixel value is the first threshold TH1b or more for each pixel included in the second image data IM, the base color remover 116 sets the base removal coefficient γ=0, and calculates the pixel value Rout of the color component R included in the base region, the pixel value Gout of the color component G included in the base region, and the pixel value Bout of the color component B included in the base region as 255, which is the upper limit pixel value, by Equation 1 to Equation 3. Therefore, the value indicated by the second base removal information in the case in which there is show-through in the second document data IM is lower than the value indicated by the second base removal information R in a case in which there is no show-through in the second document data IM, whereby the image processing apparatus 100 can remove the show-through while removing the base color.

From the above, the image processing apparatus 100 according to the present embodiment executes removal of the base color using the base removal coefficient corresponding to the feature value acquired from the document data. This enables the image processing apparatus 100 according to the present embodiment to appropriately remove a base color and show-through in accordance with the document while maintaining a pale color indicated by the document read by the document reading device.

### Second Embodiment

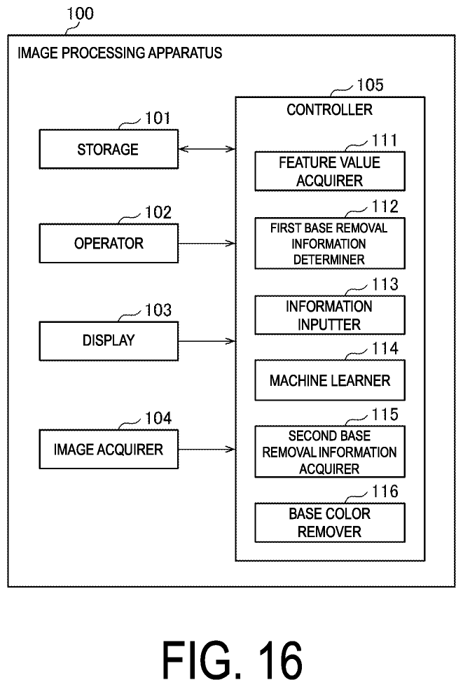

The second embodiment will be described with reference to FIG. 16. Note that, in the drawings, the same or equivalent elements are denoted by the same reference signs, and redundant descriptions are omitted. Configurations and processing having substantially the same functions as those in the other embodiments will be referred to by using the same reference characters, descriptions thereof will be omitted, and points differing from the other embodiments will be described.

The image processing apparatus 100 according to the present embodiment generates the learning model MD in which the relationship between the first feature value TV for the first image data TIM and the first base removal information TR are subjected to machine learning. Furthermore, based on the second base removal information R acquired by inputting the second feature value V for the second image data IM to the learning model MD, the image processing apparatus 100 according to the present embodiment executes removal of the color of the base region included in the second image data.

FIG. 16 is a block diagram illustrating an example of the configuration of the image processing apparatus 100 according to the present embodiment. The difference between the image processing apparatus 100 exemplified in FIG. 16 and the image processing apparatus 100 exemplified in FIG. 1B lies in that the image processing apparatus 100 exemplified in FIG. 16 includes the first base removal information determiner 112, the information inputter 113, and the machine learner 114.

In a case in which the machine learner 114 generates the learning model MD, the image acquirer 104 acquires the first image data TIM read and obtained by the image reading device. In a case in which the machine learner 114 generates the learning model MD, the feature value acquirer 111 acquires the first feature value TV based on the plurality of pixel values included in the first image data TIM for each of the plurality of pieces of first image data TIM. In a case in which the machine learner 114 generates the learning model MD, the image acquirer 104 and the feature value acquirer 111 are similar to the image acquirer 12 and the feature value acquirer 111a exemplified in FIG. 1A, and therefore detailed description will be omitted.

Furthermore, in a case in which the base color remover 116 removes the color of the base region included in the second image data IM, the image acquirer 104 acquires at least one piece of the second image data IM read by the image reading device. In a case in which the base color remover 116 removes the color of the base region included in the second image data IM, the feature value acquirer 111 acquires the second feature value V based on the plurality of pixel values included in the second image data IM. In a case in which the base color remover 116 removes the color of the base region included in the second image data IM, the image acquirer 104 and the feature value acquirer 111 are similar to the image acquirer 104 and the feature value acquirer 111b exemplified in FIG. 1B, and therefore detailed description will be omitted.

From the above, the image processing apparatus 100 according to the present embodiment generates the learning model MD by machine learning. Furthermore, the image processing apparatus 100 according to the present embodiment can achieve effects similar to those of the image processing apparatus 100 according to the first embodiment.

Each processing executed in the embodiments described above is not limited to the processing aspect exemplified in each of the embodiments. The above-described functional blocks may be implemented by using either a logic circuit (hardware) formed in an integrated circuit or the like or software using a CPU. Each processing executed in the embodiments described above may be executed by a plurality of computers. For example, the processing executed in each of the functional blocks of the controller 105 may be partially executed by another computer, or all the processing may be shared and executed by a plurality of computers.

The disclosure is not limited to the embodiments described above, and may be replaced with a configuration that is substantially identical to the configuration presented in the embodiments described above, a configuration that achieves identical operations and effects, or a configuration that can achieve an identical object. As for the disclosure, an embodiment obtained by appropriately combining technical means disclosed in different embodiments is also included in the technical scope of the disclosure. Furthermore, by combining technical means disclosed in the individual embodiments, it is possible to form a new technical feature.

What is claimed is:

1. An image processing apparatus comprising:
an image acquirer that acquires a plurality of pieces of image data read by an image reading device; and one or more controllers, wherein
the one or more controllers
acquire a density element related to density as a feature value for each of the plurality of pieces of image data,
input, to a learning model, the feature value for each of the plurality of pieces of image data and base removal information indicating a density range of a target to be removed as a color of a base region included in each of the plurality of pieces of image data, and
perform machine learning on the learning model based on the feature value and the base removal information that are input.

2. The image processing apparatus according to claim 1, wherein
the feature value further includes a saturation element related to saturation, an image object element related to an image object, and a base element related to the base region.

3. The image processing apparatus according to claim 2, wherein
the one or more controllers calculate a first frequency for each of a plurality of saturation sections indicated by a saturation histogram from pixel values included in the base region, and
the saturation element indicates a value in which the first frequency is normalized by a number of pixels of the base region for each of the plurality of saturation sections.

4. The image processing apparatus according to claim 2, wherein
the one or more controllers calculate a second frequency for each of a plurality of density sections indicated by a density histogram from pixel values included in the base region, and
the density element indicates a value in which the second frequency is normalized by a number of pixels of the base region for each of the plurality of density sections.

5. The image processing apparatus according to claim 4,
the one or more controllers determine, as the base removal information, a density range input by a user for each of the plurality of pieces of image data.

6. The image processing apparatus according to claim 4,
the one or more controllers determine the base removal information based on a distribution of values for the plurality of density sections indicated by the density element.

7. The image processing apparatus according to claim 6, wherein
the one or more controllers determine, in a case in which the distribution includes a section indicating a rise different from a peak value, the base removal information based on a density belonging to the section indicating the rise, and determine, in a case in which the distribution includes no section indicating the rise, the base removal information based on a density belonging to a section indicating the peak value.

8. The image processing apparatus according to claim 3, wherein
the image object element indicates a value in which a number of pixels of an image object included in the image data is normalized by a total number of pixels included in the image data.

9. The image processing apparatus according to claim 8, wherein
the number of pixels of the image object indicates at least any one of a number of chromatic character pixels, a number of achromatic character pixels, and a number of halftone pixels.

10. The image processing apparatus according to claim 3, wherein
the base element indicates a value in which the number of pixels of the base region is normalized by a total number of pixels included in the image data.

11. An image processing method comprising:
acquiring a density element related to density as a feature value for each of a plurality of pieces of image data read and obtained by an image reading device;
inputting, to a learning model, the feature value for each of the plurality of pieces of image data and base removal information indicating a density range of a target to be removed as a color of a base region included in each of the plurality of pieces of image data; and
performing machine learning on the learning model based on the feature value and the base removal information that are input.

12. A non-transitory computer-readable medium recording a program for causing a computer that controls an image processing apparatus to execute
acquiring a density element related to density as a feature value for each of a plurality of pieces of image data read and obtained by an image reading device;
inputting, to a learning model, the feature value for each of the plurality of pieces of image data and base removal information indicating a density range of a target to be removed as a color of a base region included in each of the plurality of pieces of image data; and
performing machine learning on the learning model based on the feature value and the base removal information that are input.
